(19) United States
(12) Patent Application Publication
(10) Pub. No.: US 2012/0199780 A1
(43) Pub. Date: Aug. 9, 2012

(54) REINFORCED UNITARY SEAT RING FOR VALVE ASSEMBLY

(76) Inventors: Frank Smith, Melbourne (AU); Shayne Benedict, Melbourne (AU)

(21) Appl. No.: 13/498,261

(22) PCT Filed: Sep. 27, 2010
(86) PCT No.: PCT/US10/50405

§ 371 Date: Apr. 24, 2012

Related U.S. Application Data
(60) Provisional application No. 61/245,774, filed on Sep. 25, 2009.

(51) Int. Cl. F16K 1/42; B21D 53/10

(52) U.S. Cl. 251/359; 29/890.122; 29/890.124

(57) ABSTRACT

A unitary valve seat has a mesh ring with an extensible annular collar connected to the mesh ring, and a resilient layer made of polyurethane which is external to the mesh ring.

### CROSS-REFERENCE TO RELATED APPLICATIONS

This application is the National Stage of International Application No. PCT/US2010/050405 filed Sep. 27, 2010 and claims the benefit of U.S. Provisional Application No. 61/245,774 filed Sep. 25, 2009.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

Improvements are needed in valve seats made of a pliable material. The valve seats must operate correctly under a variety of conditions. Such valve seats must also inhibit failure and, relatedly, inhibit pieces of the valve seat from breaking-away.

### SUMMARY

A unitary valve seat has a mesh ring with an extensible annular collar connected to the mesh ring, and a resilient layer of polyurethane or other resilient material which is external to the mesh ring.

### BRIEF DESCRIPTION OF THE SEVERAL VIEWS OF THE DRAWINGS

FIG. 1 is a perspective view of one embodiment shown mounted in a valve.

FIG. 2 is another perspective view of the embodiment of FIG. 1.

FIG. 3 is an elevation view of an embodiment of a metal ring.

FIG. 4 is a top view of the embodiment of FIG. 3.

FIG. 5 is a side view of the embodiment of FIG. 3.

FIG. 6 is an elevation view of an embodiment of an integrated and unitary annular seat.

FIG. 7 is a sectional view of the embodiment of FIG. 6.

FIG. 8 is another sectional view of the embodiment of FIG. 6.

FIG. 9 is a view of a jig embodiment.

FIG. 10 is a cut-away view of integrated and unitary annular seat.

FIG. 11 is a cut-away view of integrated and unitary annular seat.

FIG. 12 is a cut-away view of integrated and unitary annular seat.

### DETAILED DESCRIPTION OF THE PREFERRED EMBODIMENT(S)

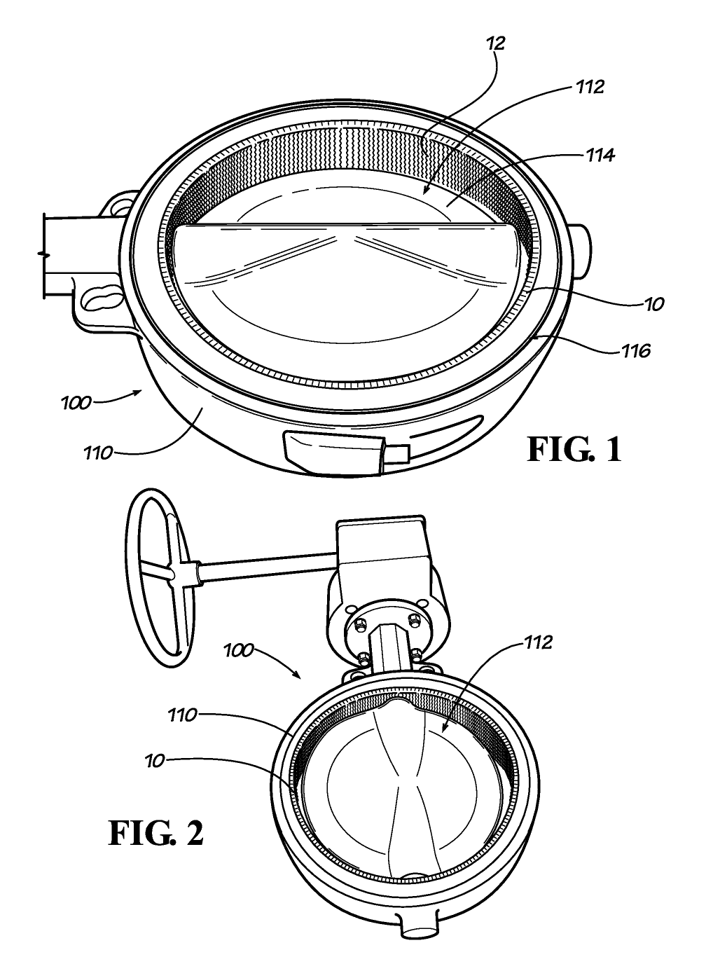

Referring to FIGS. 1-2, the integrated and unitary annular seat 10 is described below and is for use in a valve 100 having a valve body 110. The valve body 110 defines a bore 112 through the valve body 110.

The dimensions or proportions as represented in the figures of the drawings are by way of example only and are not intended to be limiting. As represented, proportions are shown for a 300 millimeter (12 inch) valve seat.

The integrated and unitary annular seat 10 has an inner surface 12 for sealing with the disc 114 of the valve 100 and an outer surface 14 (FIG. 12) for mounting the unitary annular seat 10 to the valve body 110.

The integrated and unitary annular seat 10 includes a metal insert 20. The metal insert 20 is unitary, i.e., manufactured as one piece. The metal insert 20 is preferably made of stainless steel. By way of example, but not limited to, the metal insert 20 may be made of grade 304 stainless steel. The metal insert 20 reinforces the integrated and unitary annular seat 10.

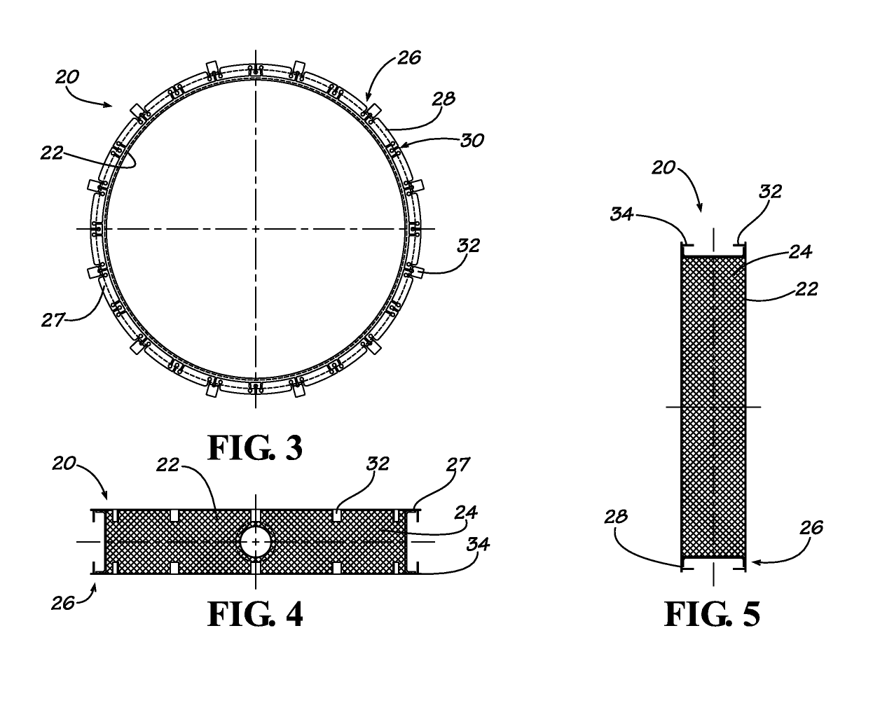

Referring to FIGS. 3-5, the metal insert 20 has a mesh ring 22 and a collar 26. The mesh has strands 24 joined together approximately at angles of forty-five degrees. All attachments made within the metal insert 20 are preferably welded. The approximate forty-five degree angle of the mesh strands 24 enables the metal insert 20 and thereby the integrated annular seat 10 to flex and/or bend. By way of example, other angles for intersecting the strands 24 may be implemented for enabling flexure; the thickness of the strands 24 may vary according to the need of the individual application; the size of the gaps in the mesh or as defined between the strands 24 may vary; and the mesh ring 22 could alternatively be made of a porous material or from an off-the-shelf screen material.

The collar 26 is an extensible annular member 27 and may be formed by ringlike piece 28 (preferably two). The thickness of the cut piece ring(s) 28 is about 0.9 mm. (or ranges from about 0.5 mm to 5 mm) allowing stability, resilience, retention and flexure. Cuttings (not shown) are removed from the ringlike piece(s) 28 to define a plurality of slits or voids 30 and a plurality of tabs 32 allowing the ringlike piece(s) 28 to accommodate (i.e. stretch into a mold and later shrink as the polyurethane or other resilient material cures). The tabs 32 preferably are shaped having three sides of a square or a rectangle, are radially the outermost portion of the ringlike piece(s) 28, and 32 are bent or turned approximately ninety degrees toward the center-line of the mesh ring 22 creating a “C”-shaped cross-section for the metal insert 20. Each consecutive tab 32 may be angularly spaced or staggered from its next adjacent tab 32 around the cut-piece ring 28 by an angle of approximately thirty degrees. The slits 30 are preferably cul-de-sac shaped, although other shapes may be implemented. The ringlike piece(s) 28 may be created using laser cutters. Sharp edges must be avoided or removed (i.e. roundness of edges 34 should be R0.5 mm to R5 mm dependant on size). This inhibits tearing of the integrated and unitary annular seat 10.

Collar 26 functions to reinforce, conform to or around, and engage the flanged face 116 of the valve body 110.

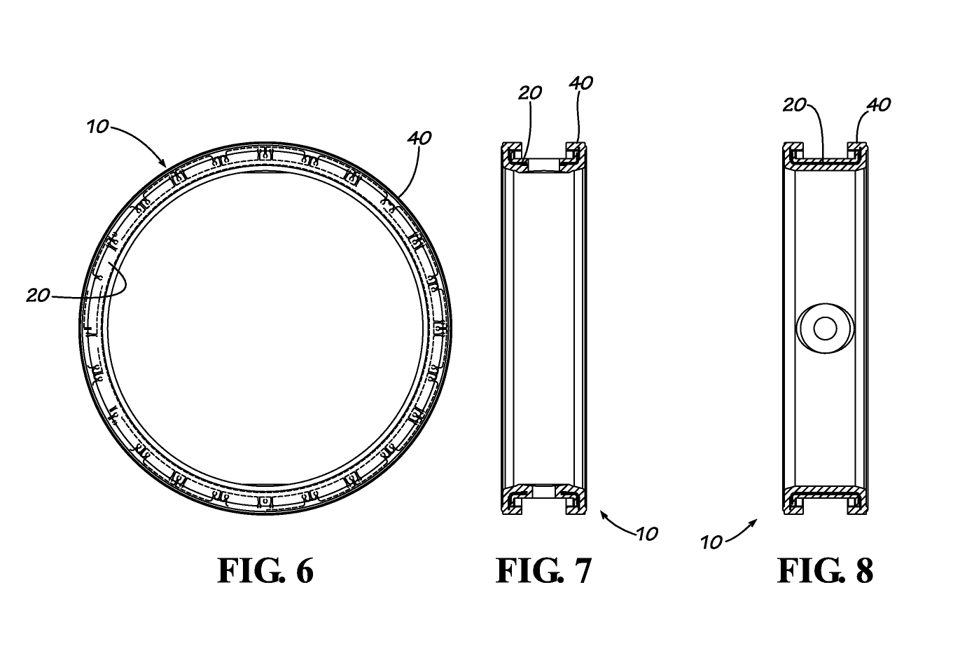

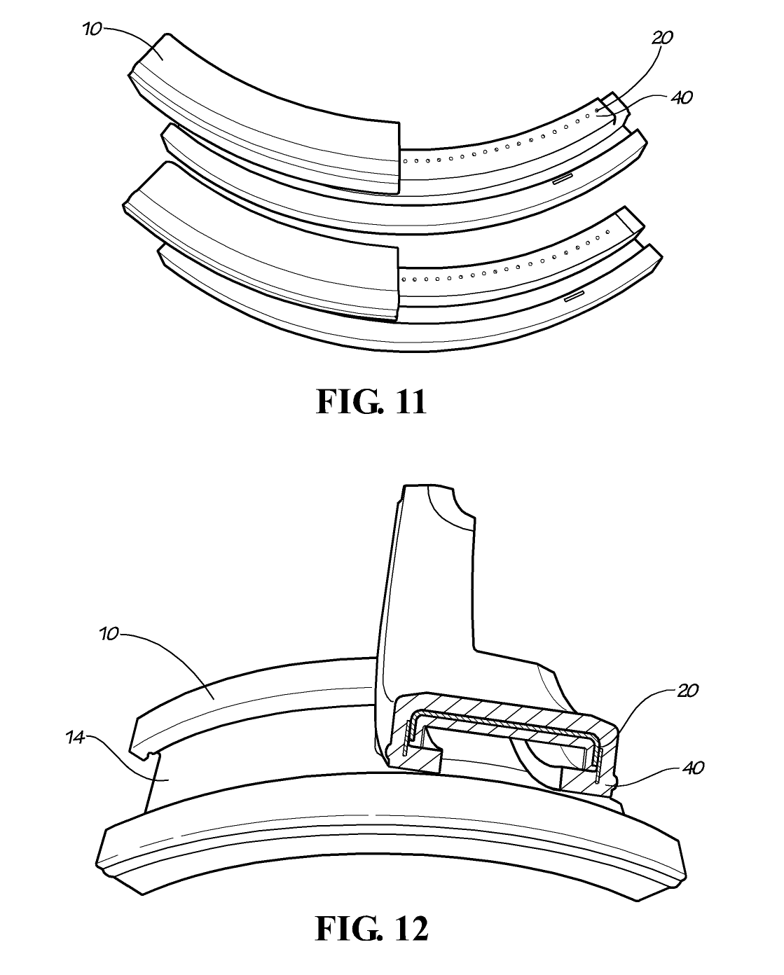

Referring to FIGS. 6-8 and FIGS. 10-12, the metal insert 20 is enclosed or surrounded by a formed polyurethane (or other resilient material demonstrating elasticity) layer 40. Hence, the layer 40 contains the metal insert 20 (i.e. there is an internal—external relationship between the metal insert 20 and the layer 40, respectively).

The polyurethane or other resilient material layer 40 may be a clear or opaque material (for example, grey). The currently preferred material for layer 40 is a polyurethane which is commercially available from a variety of suppliers in Australia.

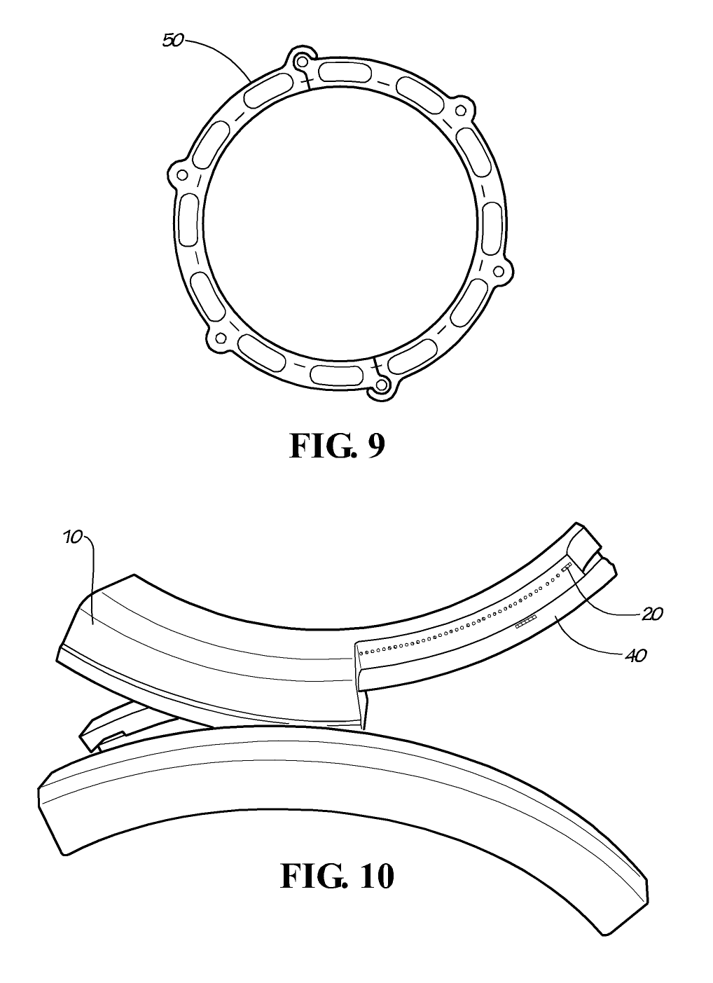

The metal insert 20 or reinforcing assembly components are assembled into a jig 50 (see FIG. 9) and spot welded together, and then removed from the jig 50 as one piece. The jig 50 gives shape to the metal insert 20 as it is built. The metal insert 20 is then fitted into a polyurethane cavity mold (not shown). The cavity mold is physically larger than the finished product it produces as it allows for shrinkage (for example, 1.5 percent shrinkage) of the polyurethane other resilient material as it cures so the metal insert 20 is designed to be extensible or expandable to fit the cavity mold. The cul-de-sac shaped voids 30 enable the extensibility or expandability of the metal insert 20.

As the integrated and unitary annular seat 10 is fitted into the valve body 110 it is required to reduce in overall diameter as it is clamped into place. The combined metal insert 20 and polyurethane or other resilient material layer 40 is designed also to allow for this compression (for example, 1.5 percent shrinkage or compression). The shrinkage occurs as unitary annular seat 10 cures. The unitary annular seat 10 with compression constrains the polyurethane other resilient material within the valve seat.

What is claimed is:

1. A unitary valve seat apparatus, comprising:
a metal insert including a means for extending said metal insert; and
a resilient layer external to said metal insert;
wherein said resilient layer is made of a polyurethane material.

2. The unitary valve seat apparatus according to claim 1, wherein said means for extending said metal insert comprises:
a mesh ring; and
a collar connected to said mesh ring wherein said collar comprises an extensible annular member.

3. The unitary valve seat apparatus according to claim 2, wherein said extensible annular member comprises:
two ringlike pieces each having a plurality of slits; and
a plurality of staggered tabs projecting from said ringlike pieces,
wherein said plurality of staggered tabs are turned toward a centerline of said mesh ring.

4. The unitary valve seat apparatus according to claim 3, wherein the plurality of slits have a cul-de-sac shape.

5. The unitary valve seat apparatus according to claim 3, wherein the plurality of slits have an edge rounded to at least 0.5 millimeters.

6. A unitary valve seat apparatus, comprising:
a mesh ring;
a collar connected to said mesh ring wherein said collar comprises an extensible annular member; and
a resilient layer external to said mesh ring.

7. The unitary valve seat apparatus according to claim 6, wherein said resilient layer is made of a polyurethane material.

8. The unitary valve seat apparatus according to claim 6, wherein said extensible annular member comprises:
two ringlike pieces each having a plurality of slits; and
a plurality of staggered tabs projecting from said ringlike pieces,
wherein said plurality of staggered tabs are turned toward a centerline of said mesh ring.

9. The unitary valve seat apparatus according to claim 8, wherein the plurality of slits have a cul-de-sac shape.

10. The unitary valve seat apparatus according to claim 8, wherein the plurality of slits have an edge rounded to at least 0.5 millimeters.

11. The unitary valve seat apparatus according to claim 8, wherein said resilient layer is made of a polyurethane material.

12. A unitary valve seat apparatus, comprising:
a mesh ring;
a collar connected to said mesh ring wherein said collar includes two ringlike pieces each having a plurality of slits, and a plurality of staggered tabs projecting from said ringlike pieces, wherein said plurality of staggered tabs are turned toward a centerline of said mesh ring; and
a resilient layer external to said mesh ring, wherein said resilient layer is made of a polyurethane material.

13. The unitary valve seat apparatus according to claim 12, wherein the plurality of slits have a cul-de-sac shape.

14. A method of assembling a valve seat, comprising the steps of:
forming and shaping a metal insert in a ringlike shape;
fitting the metal insert into a mold by extending the metal insert into a cavity of the mold;
molding a resilient layer while enclosing the metal insert within the molded resilient layer; and
curing the resilient layer around the metal insert to form a unitary valve seat, wherein the unitary valve seat is shrinking while the unitary valve seat cures.

15. The method according to claim 14, further including the steps of compressing the unitary valve seat for fitting the unitary valve seat into a valve body.
